(19) United States
(12) Patent Application Publication
(10) Pub. No.: US 2023/0060108 A1
(43) Pub. Date: Feb. 23, 2023

(54) Catalyst System for Rocket Engine

(71) Applicants: Christopher Craddock, New York, NY (US); Donald Platt, Melbourne, FL (US)

(72) Inventors: Christopher Craddock, New York, NY (US); Donald Platt, Melbourne, FL (US)

(21) Appl. No.: 17/845,811

(22) Filed: Jun. 21, 2022

Related U.S. Application Data
(63) Continuation-in-part of application No. 16/457,813, filed on Jun. 28, 2019.
(60) Provisional application No. 62/691,839, filed on Jun. 29, 2018.

(51) Int. Cl. F01N 3/08; F02K 9/97; B01J 23/34; B01J 21/04; B01J 23/42; B01J 23/44; B01J 23/50; B01J 23/86; B01J 35/04; B01J 35/00

(52) U.S. Cl. CPC F01N 3/0814; F02K 9/97; B01J 23/34; B01J 21/04; B01J 23/42; B01J 23/44; B01J 23/50; B01J 23/862; B01J 35/04; B01J 35/0006

(57) ABSTRACT

A modular reusable catalyst system is provided for a bi-propellant rocket engine and adaptable for a monopropellant, wherein a hydrocarbon fuel is combined with one or more catalysts, and can provide an additional convergent-divergent flow in combination with a thruster.

### PRIORITY

This continuation-in-part application claims priority to U.S. patent application Ser. No. 16/457,813 filed Jun. 28, 2019, which claims the benefit of U.S. Provisional Application Ser. No. 62/691,839, having a filing date of Jun. 29, 2018, the entire contents of which are all relied upon and fully incorporated herein by reference.

We, Christopher Caddock, an invention of the present invention described herein, having an address at 18 Mayberry Road, Chappaqua, N.Y. 10514, a citizen of the United States of America; and Donald Platt, an inventor of this present invention described herein, with an address at 2211 Santa Lucia Circle, Melbourne, Fla., a citizen of the United States of America have conceived an invention titled “Catalyst System for Rocket Engine.”

### FIELD OF THE INVENTION

The field of the invention relates to the design and development of a rocket engine, and more specifically, the present invention relates to the design of a catalyst system adapted for an Aerospike rocket engine and further relates to improvements to aid in the creation of a more lightweight, reliable, efficient rocket engine.

### BACKGROUND OF THE INVENTION

Conventional rocket engine technologies utilize chemical combustion in single and multistage engines to reach the upper atmosphere. The weight of the fuel and efficiency of the engine at varying altitudes often dictate current designs. In certain multistage rockets designed for orbit, when the first stage of a rocket ignites, the engine, which may be more efficient at lower altitudes, causes the rocket to lift into the atmosphere gradually. Thereafter, the first stage separates from the upper stage and ignites a subsequent engine, which may be more effective at higher altitudes. The upper or second stage may be needed to enable a payload to reach the earth's lower orbit. A more efficient, lighter, and more cost-effective design is needed.

Conventional rocket engine technologies often utilize a convergent-divergent nozzle, such as a bell nozzle, which converts the heat of exhausting flue gas into pressure (or thrust). Preferably in designing such a nozzle, the pressure of the resulting exhaust is provided to be about the same pressure as the atmosphere into which the exhaust exits. In an over-expanded nozzle, the atmospheric pressure is higher than the exhaust; the result is the opposite in an under-expanded nozzle. However, in an over-expanded state and under-expanded state, the engine does not provide optimal efficiency for conversion of fuel to thrust. Accordingly, given typical environmental constraints, designers of bell nozzles attempt to provide the best physical configuration for the bell nozzle to allow an optimal thrust for an expanded fuel mixture over a range of altitudes and atmospheric pressures that are anticipated. The bell nozzle may be under-, over-, or ideally expanded during an ascent of a flight profile; however, the inefficiency is a tradeoff for a single configuration of the nozzle for the desired engine and fuel type. See FIG. 1. FIG. 1 shows basic isentropic conceptual relations where fuel and oxidizer are introduced in an injector, are combusted in a combustion chamber, and exited through an aperture to an outward expanding bell nozzle at various altitudes and atmospheric pressures.

An aerospike engine is an alternative design utilizing an aerospike nozzle rather than a bell nozzle. Designs of aerospike nozzles can vary and include annular and linear versions. See FIG. 2, which compares portions of an aerospike engine and portions of a bell-nozzle engine.

Several aerospike engines were tested from 1997 to 2000. Because of technical problems, inherent constraints of the physical systems and materials, and high costs, the tests were discontinued. Among earlier attempts, the X—33 vehicle, a half-scale demonstrator for the proposed “Venture Star” orbital space plane, utilized a prototype aerospike engine and attempted to address certain expected issues with new technologies to be employed, among other things, metallic thermal protection systems, and cryogenic fuel tanks for liquid hydrogen.

More specifically, the engine that was utilized, the prototype XRS—2200, was a linear aerospike research engine that included 20 combustion chambers, ten aligned on each end of a ramp center body, which NASA and Rocketdyne developed. Liquid hydrogen and liquid oxygen were used with existing cooling systems—which design choice provided a significant thrust but also imposed certain limitations. See FIG. 2. Following the failure of the tested technologies, further efforts were canceled.

Other experimental attempts have also failed. For example, attempts to develop an annular aerospike nozzle have not been met with success. Among other things, erosion of the nozzle support, nozzle ablation, and cooling issues have been among the difficulties presented. Accordingly, aerospike technology is more difficult to deploy than conventional engines, which use a bell nozzle because of design, development and fabrication, and other things.

An aerospike engine is an alternative design intended to permit a spacecraft to leave the atmosphere while maintaining thrust efficiency from ground level to the upper reaches of the atmosphere, but it also provides other advantages over traditional bell nozzle designs. Nevertheless, design complexities, reliance upon traditional techniques and conventional fuel types, and limited test data, among other things, have hindered advances in this type of engine.

Accordingly, there has been a long-felt need for an improved rocket engine design that addresses the aforesaid problems and provides a more efficient, effective, lighter, and more cost-effective design.

### SUMMARY OF THE INVENTION

The instant invention relates to a catalyst system, and in particular a catalyst system adapted for an aerospike rocket engine system. The catalyst system includes a container having a fuel input at one end and, an opening for an exhaust another end. Near the fuel input, a fuel spreader plate is provided which can spread fuel over a catalyst that neither provided in the catalyst chamber within. In addition, an orifice plate is provided after the catalyst to constrain the flow of the expanding of resulting fuel and catalyst. In addition, a supplemental port is provided and connected to a perimeter wall of the catalyst chamber in order to deliver supplemental fuel, oxidizer or catalyst refill into the chamber. Preferably the supplemental port is provided at a downstream end of the catalyst chamber near the orifice plate, at a region where a substantial amount of the fuel and catalyst have already mixed before introduction of the oxidizer.

The catalyst system chamber is designed to provide for convergent flow within the chamber and the expanding mixture exits through the orifice plate, and becomes divergent at an exhaust end of the system.

The catalyst system can also include a thrust ring, which is removably for engine designers to add one or more catalyst packages into the catalyst system from the exhaust end. The thrust ring can be adapted to include connectors to a thruster which can be provided to receive the exhaust from the catalyst, system at its exhaust end.

One particular catalyst for use in the system is alumina foam impregnated with potassium permanganate, which can be combined with fuel such as kerosene, or RP-1, and a further oxidizer such as hydrogen peroxide can be used.

The system can be adapted for modular use, where a number of prepackaged catalyst packages can be provided and packed into the system for dry fueling of the rocket engine. Where multiple catalysts are used, the catalysts are separated to allow upstream catalysts to react before expanding fuel catalyst mixture blows through the system. Separators include nonconsumable materials such as steel, and can also include reactive materials such as platinum, palladium, and silver oxide to supplement the catalyzing of fuel and oxidizer.

Other types of catalyst packages can include sintered ceramic pellets impregnated with potassium permanganate surrounded by wire mesh.

It is to be understood that both the foregoing description and the following description are exemplary and explanatory only and are not restrictive of the invention, as claimed. Specific examples are included in the following description for purposes of clarity, but various details can be changed within the scope of the present invention.

### BRIEF DESCRIPTION OF THE DRAWINGS

A preferred embodiment of the invention has been chosen for detailed description to enable those having ordinary skill in the art to which the invention pertains to understand how to construct and use the invention readily and is shown in the accompanying drawings in which:

FIG. 1 is a perspective view depicting examples of a traditional bell nozzle.

FIG. 2 is a diagram of a traditional bell and an aerospike rocket engine.

FIG. 3 is a diagram comparison of the exhaust plume from a traditional bell nozzle and an aerospike nozzle.

FIG. 4 is a perspective view of an image of one embodiment of an aerospike nozzle according to the invention.

FIG. 5A is a conceptual diagram of one embodiment of an aerospike engine according to the invention.

FIG. 5B is a conceptual diagram of one embodiment of an aerospike engine according to the invention.

FIG. 6 is a perspective and side view of an embodiment of an aerospike component for an aerospike engine according to the invention.

FIG. 7 is a conceptual drawing of a side view of an embodiment of an aerospike component for an aerospike engine according to the invention.

FIG. 8 is an image showing a side perspective view and a top perspective view of an embodiment of an aerospike nozzle according to the invention, including a needle spike.

FIG. 9 is a conceptual drawing showing a side view of an embodiment of a portion of an embodiment of an aerospike engine according to the invention.

FIG. 10 is a conceptual drawing showing a side view of a portion of an embodiment of an aerospike engine according to the invention, including a portion of a combustion chamber and nozzle for at least one thruster.

FIG. 11 is a conceptual diagram of a portion of an embodiment of an aerospike engine, including an embodiment of a catalyst package according to the invention.

FIG. 12 is a conceptual diagram of a portion of an alternative embodiment of a catalyst system according to the invention.

FIG. 13 is a conceptual diagram of a portion of an alternative embodiment of a catalyst system according to the invention.

FIG. 14 is a conceptual diagram of a portion of an alternative embodiment of a catalyst system according to the invention.

FIGS. 15A-15B are conceptual diagrams of a portion of an alternative embodiment of a catalyst system according to the invention.

FIG. 16 is a conceptual diagram of a catalyst system according to the invention and thruster and are shown in a 3-dimensional exploded view.

FIG. 17 is a conceptual diagram of a portion of a catalyst system according to the invention shown in a 3-dimensional exploded view.

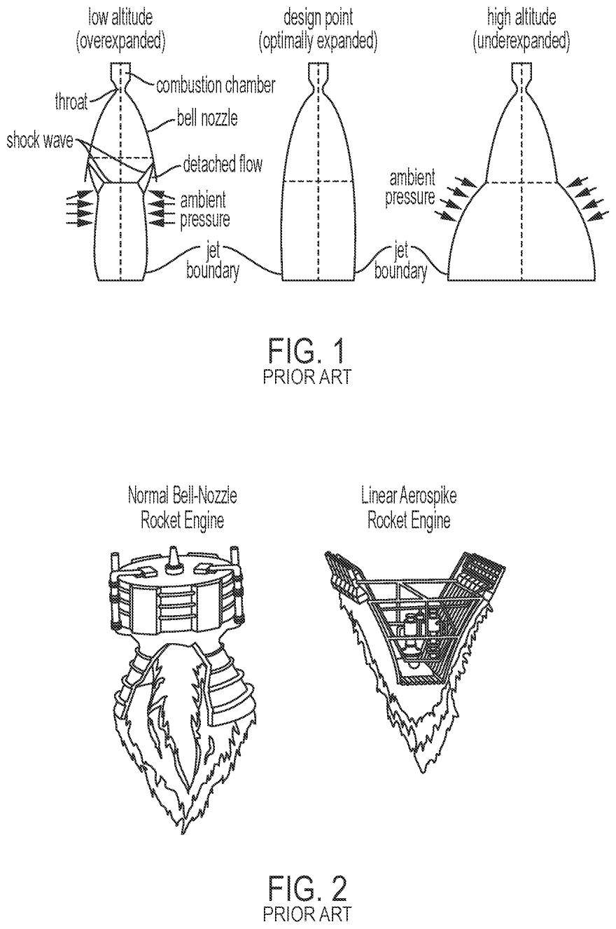

The above-referenced figures are not to scale and are for reference only in assisting the reader in understanding the invention in conjunction with the detailed written description which follows.

### DETAILED DESCRIPTION OF THE INVENTION

A catalyst system according to the invention adapted for an aerospike rocket engine the invention is herein provided, which addresses the drawbacks and inefficiencies that have heretofore hindered the development of this aerospace engine technology.

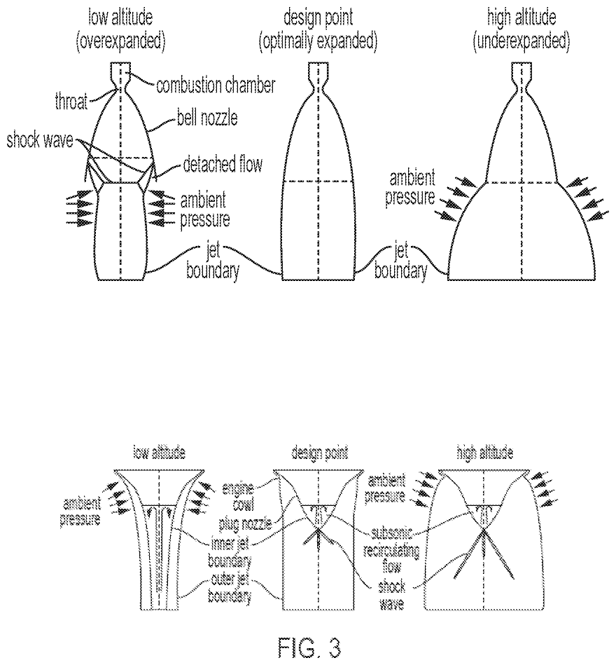

A significant difficulty in developing an efficient aerospike engine is the complex flow field it provides over varying conditions such as altitude. At low altitudes, the plume structure of the jet exhaust is separated at its base and is called “open wake mode.” For higher altitudes, the converse is true; where the ambient pressure is low, the base flow field becomes closed, closing the wake, where base pressure is constant. See FIG. 3.

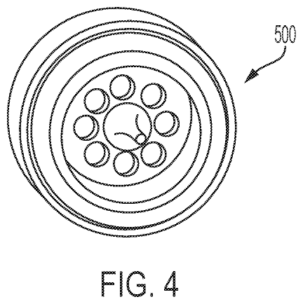

Referring to the drawings, FIG. 4 illustrates a preferred embodiment of a system according to the invention, having parts described more thoroughly herein. Specifically, in FIG. 4, an embodiment of an aerospike engine 500 according to the invention is shown from a three-dimensional perspective view (not to scale).

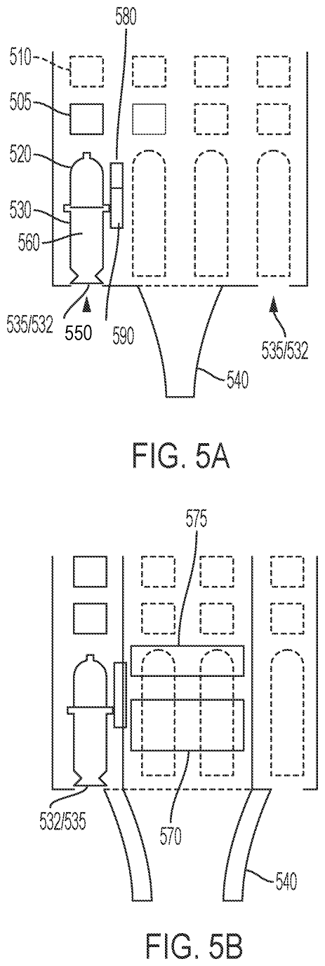

In FIG. 5A, a preferred embodiment of an aerospike engine 500 according to the invention is shown. It includes a fuel system 505, a catalyst system 520, a fuel and catalyst control system 510, at least one thruster 530, and an exhaust control spike 540.

More specifically, as shown in FIG. 5A, each thruster has a nozzle 550 and one or more combustion chambers 560. A plurality of thrusters 530 is arranged around the exhaust control spike 540. In one embodiment, the thrusters 530 are arranged in a circular configuration whereby, when in operation, each thruster provides an exhaust. The combined exhaust from the thrusters cooperates with the exhaust control spike to provide a combined thrust. One benefit of this arrangement is that the thrusters can be individually controlled to provide directional thrust.

An aerospike engine system 500, according to the invention, can also include one or more additional systems, depending on mission requirements, including an intermediate catalyst control system 590 and a fuel and catalyst mixture control system 580, as further described herein. A more detailed description of specific components will follow.

In a preferred embodiment, the system is adapted for use with a fuel such as kerosene or RP-1 and one or more types of oxidizers, such as hydrogen peroxide, and one or more forms of catalysts, such as various forms of potassium permanganate, whether in solid pellet form or in solution. Other catalysts can include platinum, palladium, and silver oxide, which can be provided in various forms such as a screen or mesh. A benefit of such a choice of fuels, oxidizers, and catalysts is safety and cost. These substances can be used at room temperature—avoiding complicated fuel cooling systems—and provide greater safety and simplicity than traditional fuel choices. Traditional fuel sources such as liquid hydrogen and liquid oxygen are highly volatile, reactive, and difficult to maintain.

Accordingly, a fuel system 505 includes at least one fuel container and one or more fuel control valves. The fuel system 505 is operatively connected to the catalyst system 520 to provide a fuel, such as kerosene, to a fuel inlet at one end of the catalyst system 520. In addition, the fuel system may also include a liquid oxidizer, such as hydrogen peroxide, which is operatively connected to the catalyst system 520. The fuel system 505 is controlled by a fuel and catalyst control system 510.

A fuel and catalyst control system 510 can include a device such as a computer or ASIC as can be appreciated by persons of ordinary skill in the art and is operatively connected to the fuel system to control the flow of fuel into the catalyst system 520. The fuel system 505 can also include the electrical, hydraulic, and fuel lines (not shown) such as used by conventional systems, such as electrically controlled flow valves. It can thereby control each individual thruster and any refueling thereof. In addition, a separate catalyst mixer control system 580 can be provided or incorporated as part of the fuel and catalyst control system 510 to provide a specific control system to control the rate of flow of oxidizer/second catalyst. An intermediate catalyst control system 590 can also be provided depending on mission parameters and can be a redundant device such as a computer or ASIC, or a simple electromechanical system operatively connected to the fuel system 505 and catalyst system 520, and controlled by the catalyst mixture control system 580. The system is adapted to differentiate between the control of oxidizer and liquid catalyst that may be introduced through a supplemental liquid catalyst/oxidizer port.

Specifically, the fuel and catalyst mixture control system, can be provided to start, throttle, and shut down fuel entering the catalyst system. In addition, the fuel and catalyst mixture control system fuel can also provide a throttle of each thruster individually. In addition, the catalyst mixture control system 580 can be adapted to control in-flight or in-orbit refueling of the catalyst system.

Shut down and restart, capability of an engine is important for engine design for orientation and or to change, as well as being useful for continuous flight and maneuverability. An engine that has multiple chambers that are individually throttleable can permit thrust vectoring while also being more efficient in space travel. For example, such an engine is helpful to provide a vehicle that cannot only deliver payload but turn, orient, deorbit, as well as reenter the atmosphere on the land. The above engine design flexibility for the choice of fuels and catalysts such as peroxide, kerosene, and potassium permanganate, among others.

One such design includes having liquid oxygen and methane fuel sources and a preferred nozzle design, namely an annular conical isentropic truncated aerospike nozzle. The particular design of this engine can also include bleed compensation for a single stage.

An embodiment of an aerospike engine, according to the invention, can be adapted for other fuel types. For example, an aerospike rocket engine can be provided with two catalysts for the aerospike engine chambers, namely a primary fuel such as liquid hydrogen and a primary oxidizer such as liquid oxygen. Alternatively, other fuels that can be used include methane and peroxide or kerosene. For example, in a further embodiment, the primary oxidizer can be fed from a peroxide generator as part of the main fuel of the fuel system 505, and accordingly, the catalyst system described above is adapted for this purpose.

For both catalysts, other catalytic material could be used in place of potassium permanganate. These include manganese dioxide, palladium, or silver oxide, among others. Other liquid catalysts can also be used.

In a further embodiment, fuel can be introduced to the combustion chamber 560 at a point after the catalyst system 520. (not shown). In such a variation, as the hot gas enters the combustion chamber, it ignites the hydrocarbon fuel automatically without the need for an igniter.

In addition, the fuel and catalyst, mixture control system 580 can be provided to shunt exhaust gas from a catalyst system to power the turbine system 570. The fuel and catalyst mixture control system can also be adapted to control a separate turbine system 574 for use in conjunction with the aerospike engine. It can be appreciated by a person of ordinary skill in the art that contemporary turbine or turbofan systems can be adapted for use with an embodiment aerospike engine according to the invention.

In an embodiment of the invention, the fuel introduced to the catalyst system can be pressure fed. However, it can be appreciated that a gas generator cycle can be provided for the power cycle of a bi-propellant rocket engine, whereby some of the propellants are burned in a gas generator. The resulting hot gas can be used for a turbine system 570 or to power the engine pump while the gas is then exhausted. The fuels enter the combustion chambers, whereupon the combination is ignited, combustion occurs, and the resultant hot gas is then passed through the aerospike nozzle to produce thrust.

An aerospike engine system 500 can also include one or more additional systems, depending on mission requirements, including a second or alternative fuel system, an ignition system, a thermal protection system, a pre-burner, fuel inlet, fuel pump, cryo-control system, and heat exchanger, among other things.

Fabrication of an aerospike engine includes choosing lightweight materials that can perform under the rigors of the rocket engine and can include SiC or SiC composite for the composition of the spike, which has good heat resistant characteristics. Titanium 6-4 also has good, characteristics.

In addition, the cooling of engine parts can be provided by using cooling channels. Other high-performance materials such as organic matrix composition copper alloy (OMC) have been used in combustion chambers, whereas other structural support materials can be fabricated from a stainless-steel alloy.

In a further embodiment, as shown in FIG. 5B, a plurality of thrusters 530 can be arranged around an exhaust control spike 540, having an internal aperture to receive exhaust from a turbine system 570. It can be appreciated by a person of ordinary skill in the art that the turbine system 570 includes conventional components found in existing turbine systems and can include a separate turbine power system 575 for providing an independent combustion source for powering the turbine system 570.

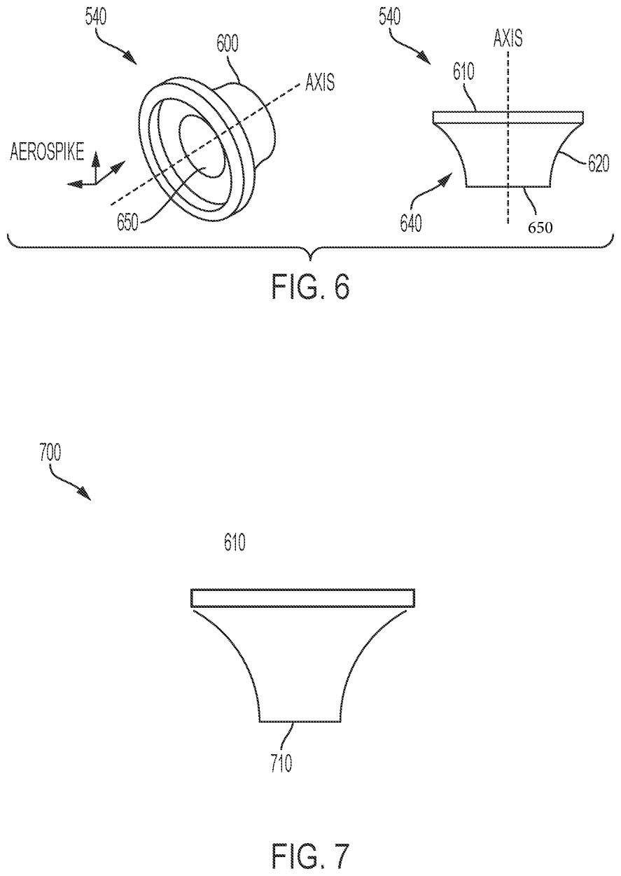

In FIG. 6, an embodiment of an exhaust control splice 540 according to the invention is shown (also referred to as “aerospike” or “aerospike nozzle” or “plug nozzle”) and is provided as an annular aerospike 600. The annular aerospike can be generally characterized by having a base portion 610, a tapered neck portion 620, and a tip or end portion 630. It can be appreciated by a person of ordinary skill in the art that the aerospike can be linear or conical. In a preferred embodiment, the exhaust control spike 540 has an annular shape that tapers to an annular plug having a generally concentric exhaust aperture 650 extending from the base to its end.

As shown in FIG. 7, an alternative embodiment of an exhaust control spike 540 can be provided, having a conical aerospike 700, which tapers to a solid plug 710.

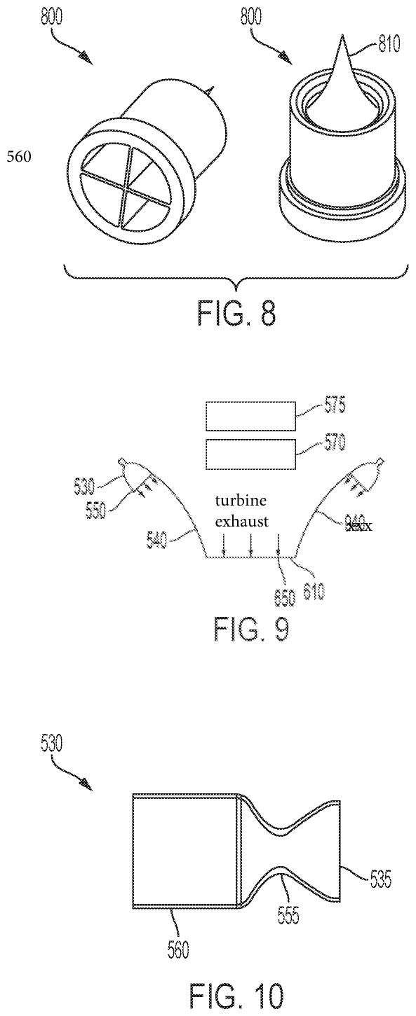

As shown in FIGS. 5A and 5B, a control spike 540 is provided wherein the spike is truncated. In an alternative embodiment, such as shown in FIG. 8, the exhaust control spike 540 is provided as a conical needle aerospike 800 that is not truncated but forms a sharp spike or needle 810. The embodiment shown in FIG. 8 can be provided with a single combustion chamber 560 or a plurality of partitioned combustion chambers 560 to receive a plurality of exhausts from multiple thrusters 530.

It can be appreciated toy a person of skill in the art of aerospike engine design that several parameters play an important role in the design of an aerospike engine. The type of nozzle, whether it is linear, annular, or tile shaped, as well as the nozzle contour, thrust performance factors, and flow field, are important considerations.

An aerospike, according to the invention, utilizes aspects of a plug nozzle and has a conical shape with a curved and pointed spike. The gradual conical base to spike shape allows the exhaust gases to expand through an isentropic or constant entropy process. Accordingly, the nozzle's efficiency is maximized, and little or no energy is lost due to the turbulent mixing of exhaust flow. Theoretically, the curved spike must be of infinite length for ideal implementation, but this is not possible. There is a tradeoff between the form of the exhaust plume and aspects of the physical means of boundary constraint imposed by the spike. It has an inner boundary and can be described as a radial “inflow” type of nozzle, meaning the expansion of the outward flow is towards the nozzle axis. There is also a secondary flow circulation which looks like an aerodynamic spike and thus is named “aerospike.” The choice of spike length is a tradeoff between weight and efficiency.

A preferred embodiment of an aerospike, according to the invention, is partially cut off or truncated. This reduces the weight with a modest decrease in efficiency. The length of the spike and amount of truncation depends on the base pressure, i.e., the pressure generated by the exhaust flow over the base and the timing or transition of the closed wake from the exhaust flow.

In alternative embodiments, the exhaust control spike can also be provided with a throat insert and spike rod. Portions of the exhaust control spike 540, such as the spike rod and throat insert, if provided, can be manufactured out of graphite.

As shown in the conceptual drawing of FIG. 9, a further embodiment of an aerospike engine system having an annular aerospike, such as those shown in FIG. 5B and FIG. 6, is provided with a plurality of thrusters 530 surrounding the aerospike 540 and turbine exhaust aperture 650 wherein the exhaust from the plurality of thrusters 530 meet with exhaust from a turbine system 570 at the base 610 of the aerospike. As there is no outer boundary, the atmospheric pressure acts as an outer boundary constraining the gas jet exhaust. In this embodiment, the exhaust of each nozzle 550 is directed towards and parallel to the surface of the aerospike where the nozzle 550 meets or is proximate to the control spike 540. This orientation shown in FIG. 9 is exaggerated for illustration purposes only and is not to scale.

In other words, the nozzle ramp of the aerospike nozzle is equivalent to the bell nozzle's inner wall, and atmospheric pressure acts as the outer wall. The combustion gasses parallel to the nozzle ramp and the atmospheric pressure work together to produce thrust. The efficiency behind the aerospike nozzle is due to the exhaust recirculating near the base of the spike and raising the pressure in that area to almost the equivalent of the surrounding pressure. As a result, the exhaust virtually offsets the aerodynamic forces acting on the rocket. Thus, the rocket engine does not lose thrust.

FIG. 10 is a conceptual drawing showing greater detail of portions of the thrusters 530 shown in FIG. 5A. Each of the plurality of thrusters 530 is provided with an asymmetrical conical or contoured nozzle 550 having an exhaust aperture 535, a throat 555, and a combustion chamber 560. The dimensions of the throat of the nozzle of the thruster are adapted to accommodate the high pressure and flow rate of a solid motor. Preferably, the fuel and catalyst control system 510 provides optimal aerospike nozzle parameters that can be provided for isentropic, inviscid, and irrotational supersonic flows for any user-defined exit Mach number and mass flow rate.

With reference to the embodiment of the invention shown in FIG. 5A, the annular aerospike is provided having such clustered cell nozzles of the thrusters 530 placed proximate to one another with each exhaust aperture 535 directed towards the aerospike. Problems faced by such a design include complicated flow fields and gaps that create performance losses, as well as the interaction of differential expansion of adjacent jets.

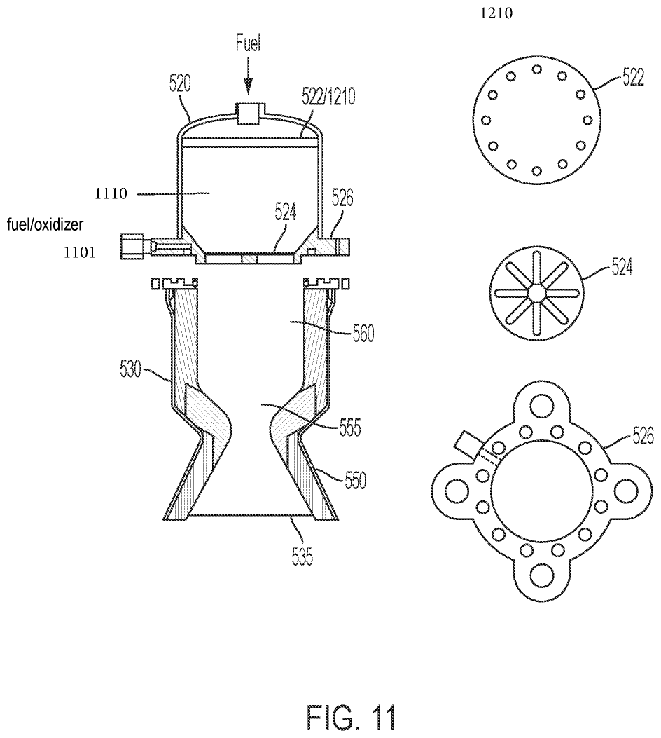

FIG. 11 shows a cross-section of the thruster section 530 connected to a catalyst system 520 according to the invention. A thruster section 530 includes at one end a region for receiving exhaust from the catalyst system 520, and at a second end, a further region for directing the combustion materials to the exhaust aperture 535. Exhaust falling from the exhaust aperture 535 is directed to the exhaust control spike 540 in combination with other thrusters 530.

The design of the cell nozzle affects the performance of the engine. The throat of the cell nozzle should be such that it boosts the velocity of the flow to a sonic speed, and thereafter expansion further increases its velocity. The heat load on the throat area can be significant. The exit of the cell nozzle should contour to permit the flow exiting to flow smoothly over the surface of the aerospike without creating disturbance and or eddies. In addition, the gaps between adjacent cell nozzles should be maintained at a minimum to avoid turbulence and differential effects. In one embodiment, the cell nozzles are preferably fabricated with titanium (TI-6-4) and Molybdenum alloy as a high-temperature materials. Other portions of the ceil nozzles and injectors of the catalyst system 520 can be made of aluminum alloy, and an outer combustion chamber can be provided with steel and lined with an ablative liner made out of silk fibers, phenolic resin, and/or phenolic glass. Additionally, the thruster can include a silicon/phenolic ablative liner.

FIG. 11 shows a catalyst system and thruster according to the invention that is reusable and can be adapted for a modular system for use with one or more catalyst packages. The catalyst system is provided with a container 520/1110 for the modular system that is intended to be filled or packed from one end, such as the exhaust end. The catalyst system includes an aperture or port at one end for receiving fuel, such as kerosene, RP-1, or hydrogen peroxide, and mixing and combining the fuel with one or more catalysts within the catalyst chamber 1110. The catalyst system 520 includes one or more flow constrictor plates 1210, such as a spreader plate 522, orifice plate 524, and a thrust ring 526.

A spreader plate 522 can be provided to distribute fuel that has been received by the catalyst system to areas of the internal catalyst system chamber 1110 containing one or more catalysts. One embodiment of a spreader plate, according to the invention, is a solid plate having a pattern of apertures extending through the plate through which the fuel can pass. In one embodiment, the spreader plate has a repeating pattern of 128 holes of 0.065 diameter mm evenly spread around the perimeter or within a grid. Beneath the spreader plate and within the catalyst system 520, one or more catalysts or modular catalyst packages can be provided, such as potassium permanganate provided in pellet form. The catalyst system 520 also includes a supplemental port 1101 to distribute an oxidizer within the catalyst system 520 at an intermediate region of the catalyst chamber and preferably proximate to the orifice plate. For example, the supplemental port 1101 can be a ring tube connected at one end for fluid connection to the catalyst mixture control system 580 at one end and having at least one aperture which provides for the flow of oxidizer or catalyst at a perimeter into the chamber. Preferably, the supplemental port 1101 distributes an oxidizer, such as hydrogen peroxide, at a point after the first catalyst has been mixed with the fuel and above the orifice plate 524 or thrust ring 526. It can be appreciated by that the supplemental port 2101 can be connected to the fuel system 505 and can receive an oxidizer (or catalyst for refueling) by being operatively connected to the fuel and catalyst control system 510 to control the flow of the oxidizer, such as concentrated hydrogen peroxide.

In an alternative embodiment, the supplemental port 1101 provides an additional catalyst for refueling the catalyst chamber.

The orifice plate 524 is provided to create a convergent-divergent section within the catalyst system but just prior to exhaust to the combustion chamber. In one embodiment, the orifice plate is provided as a solid plate having several apertures there through. The apertures are arranged radially from the center of the orifice plate 524 and can have an elongated form. The radial pattern from perimeter to center promotes flow from the convergent to the divergent exhaust region. Accordingly, the orifice plate provides a constricting flow of the fuel catalyst mixture as an expanding gas and allows that mixture to pass through the apertures to a divergent region following the orifice plate more effectively.

The thrust ring 526 is provided for further directing the resulting expanding gas-fuel-catalyst mixture to a combustion chamber 560. The thrust ring 526 can also provide a connection from the catalyst system 520 to the thruster 530. More particularly, the thrust ring allows a modular catalyst system 520 to be added to an existing thruster for a reusable system.

It can be appreciated by a person of ordinary skill in the art that various embodiments of the invention can be provided where one or more of the flow constriction devices can be disposed in different areas. For example, in one embodiment shown in FIG. 11, a spreader plate can be disposed at a top portion of the catalyst system 520 at a region where the catalyst system receives a fuel source. The orifice plate 524 can be provided near or at a bottom portion of the catalyst system, and the thrust ring 526 can be provided after the orifice plate 524 and at a bottom portion of the catalyst system 520.

As described above, an oxidizer, such as hydrogen peroxide, can be provided through a supplemental port 1101 disposed between the orifice plate 524 and spreader plate 522, and provide the fuel into the internal catalyst system chamber 1110.

Alternatively, a catalyst, such as potassium permanganate, as described above, can be provided through the supplemental port 1101 for initial filling or refueling. Accordingly, such further embodiments of the invention are advantageous for single-stage to orbit vehicles and reusable craft. Furthermore, various fuel choices are permitted, allowing for vehicles intended for multiple uses and inflight or in-orbit refueling, as described further below.

Several alternative embodiments of a catalyst system 520 having more than one catalyst are provided. A benefit of these arrangements is to provide the engine designer with the flexibility of packaging catalyst sources to satisfy various mission parameters and can be designed as a bipropellant or monopropellant system.

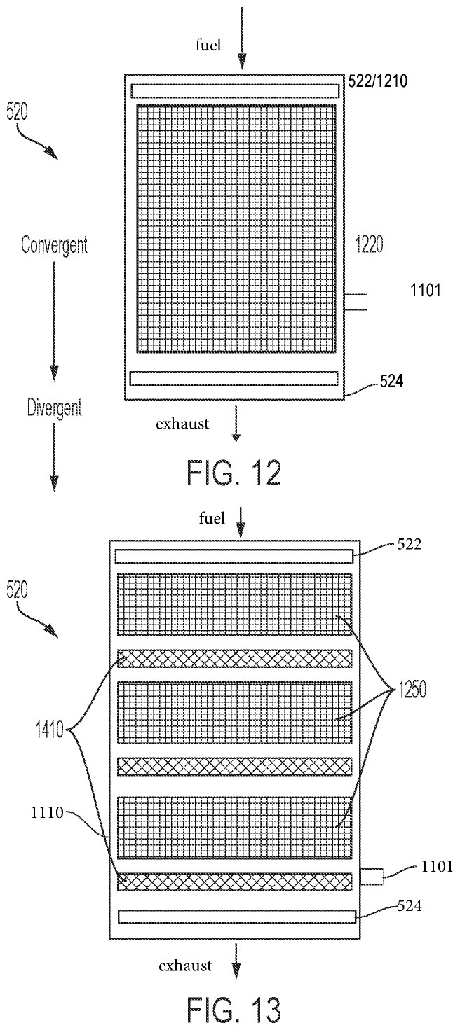

In one embodiment, as shown in FIG. 12, a matrix of at least a first catalyst 1220, such as solid sintered potassium permanganate pellets, is provided within the catalyst system chamber 1110. A separator 1410, such as a mesh steel screen, is provided to package or separate the catalyst from a lower section of the catalyst system chamber 1110. The separator preferably includes a steel mesh, but other materials such as aluminum, carbon fiber, and nonreactive ablative material are envisioned as may be developed within the scope of the invention insofar as it maintains structural integrity to prevent the reacting material from passing through the vessel before sufficient reaction occurs. A spreader plate 522 (such as shown in FIG. 11) can also be included at the top or inlet area of the catalyst system chamber 1110, and an orifice plate 524 (such as shown in FIG. 11) can be provided at the bottom or exit end at the exhaust region of the catalyst system chamber 1110.

A supplemental oxidizer or catalyst in liquid form, such as concentrated hydrogen peroxide, can be provided to mix with the resulting mixture of fuel and the at least one first catalyst within the chamber. The supplemental oxidizer or catalyst can be introduced via a supplemental port 1101 either at an intermediate region of the chamber 1110 or at or near the bottom thereof.

In a preferred embodiment, the at least one first catalyst is provided as a monolithic alumina foam (aluminum oxide) which can be impregnated with a catalyst such as potassium permanganate. Upon complete reaction, such material may be expected to be consumed. This system allows for a single monolithic catalyst without requiring integrity screens, such as a separator 1410. Alternatively, the first catalyst could include a non-consumable catalyst that can react with the fuel. Such a non-consumable catalyst can include a wire mesh of steel, platinum, palladium, or silver oxide, or a combination of these metals. Alternatively, a matrix of porous or hollow pellets comprised of such metal can be used.

In addition, the first catalyst could include a nonreactive matrix, such as a monolithic alumina foam, and initially be provided with a consumable first catalyst. Once the first catalyst is consumed, an additional first catalyst, can be provided through a supplemental port 1101 to refuel the chamber. Catalysts can also be comprised of aluminum oxide ceramic pellets saturated with potassium permanganate (sintered) and may be preferable for different embodiments of the invention. These ceramic pellets can be baked to embed the potassium permanganate in an alumina matrix. It can be appreciated by a person of ordinary skill in the art that appropriate catalyst and fuel combinations require different forms and quantities depending on the choice of fuel and catalyst, and as may be required by various mission parameters.

In a further alternative embodiment, as shown in FIG. 13, a plurality of catalysts packages 1250 can be provided. Each of the catalyst packages 1250 includes a consumable and/or non-consumable first, catalyst 1220, which can be contained within a steel mesh cage, or another similar separator 1410 as necessary to maintain separation of any catalyst provided in pellet form. As before, the separator 1410 preferably comprises a material that does not react with the first catalyst and maintains its structural integrity as the fuel and catalyst reaction occurs during mixing.

Additional porous separators 1410, such as finer steel mesh, are provided between each catalyst package 1250. In the embodiment shown in FIG. 13, the separators 1410 are provided as steel mesh whose mesh grid is disposed approximately 45° out of alignment with the mesh grid of an adjacent catalyst package 1250, thereby providing a partial flow constriction and provide containment of catalyst material.

Alternatively, at least one of the separators 1410 can provide flow constriction by providing a finer grade mesh grid to constrict the flow of fuel and or fuel/catalyst mixture. For example, the separator 1410 at the bottom or exit end of the chamber 1110 can provide flow restriction in lieu of requiring an additional spreader plate 522 or orifice plate 524.

As before, an oxidizer or supplemental catalyst in liquid form can be introduced into the chamber 1110 at an intermediate point or at or near the bottom of the chamber.

In an alternative embodiment, at least one of the separators is provided as a mesh of a metallic catalyst—such as silver or platinum—which reacts with the second or supplemental catalyst or oxidizer, such as hydrogen peroxide, thereby ensuring complete reaction and efficient use of fuel and catalyst materials.

A spreader plate 522 (such as shown in FIG. 11) can also be included at the top or inlet area of the catalyst system chamber 1110, and an orifice plate 524 (such as shown in FIG. 11) can be provided at the bottom or exit end at the exhaust region of the catalyst system chamber 1110.

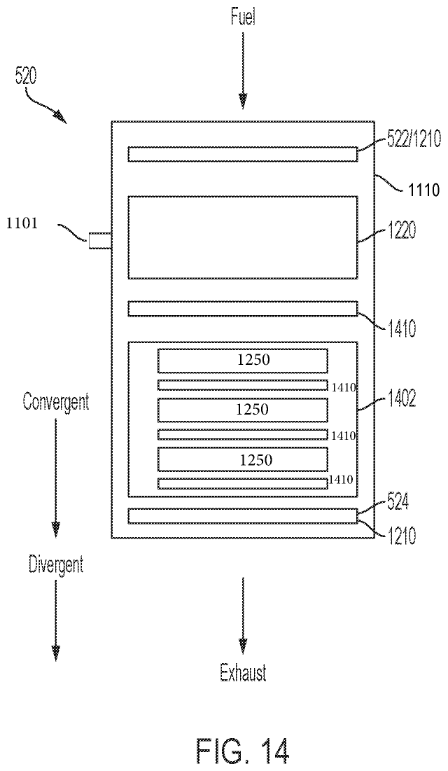

FIG. 14 shows a further embodiment of a catalyst system 520 in accordance with the invention, which is a modified version of the above two embodiments. In this embodiment, the catalyst system includes a plurality of modified catalysts systems. For example, a first catalyst system 1401 is provided as a first catalyst 1220 such as shown in FIG. 12, which is preferably provided as a monolithic alumina foam (aluminum oxide) impregnated with potassium permanganate. This system allows for a single monolithic catalyst without requiring integrity screens 1410. Alternatively, this first catalyst 1401 can be provided as a porous nonreactive material such as monolithic alumina foam, with or without a solid catalyst, such as potassium permanganate. In an alternative embodiment, the portion of the container 1101 having the first catalyst can be refueled with a supplemental catalyst via a supplemental port 1101, or an oxidizer can be introduced as a fuel.

In the embodiment shown in FIG. 14, a second catalyst system is also provided in combination with the first to provide an additional or second catalyst 1260. This can be provided as the primary catalyst for combusting with the fuel. In this embodiment, a second catalyst 1260 is preferably provided as a solid reactive material maintained in a nonreactive matrix, such as aluminum oxide ceramic pellets saturated with potassium permanganate (sintered). These ceramic pellets have been baked to imbed the potassium permanganate in an alumina matrix. As in the embodiment of the catalyst system shown in FIG. 13, steel mesh integrity screens 1410 can be provided to separate layers of second catalyst material, which package the material as one or more catalyst packages 1250, while also permitting fuel and fuel/catalyst mixture to flow through the screens. Thus, multiple layers or packages 1250 of these second catalyst materials can be provided.

As shown in FIG. 14, a separator screen 1410 can be provided to separate the first catalyst system 1401 from the second catalyst system 1402 and prevent the reacting materials from becoming blown through the chamber too quickly and allow sufficient time for the mixing of material to permit efficient reaction. A spreader plate 522 can also be included at the top or inlet area of the catalyst system chamber 1110, and an orifice plate 524 can be provided at the bottom or exit end at the exhaust region of the catalyst system chamber 1110.

Such an embodiment can be described as a bi-propellant system when used in conjunction with a liquid catalyst or oxidizer introduced through a supplemental port 1101.

Thus, the combined use of separators—including flow restrictors such as a spreader plate, orifice plate, thrust ring, and/or stainless steel screens—can be provided not only for separating various catalysts in the catalyst system and control the rate of the decomposition of catalyst but can also provide flexibility of design of the catalyst system 520 to obtain the benefit of convergent and divergent regions of combustion within the catalyst system 520 and exhaust to the combustion chamber 560 of the thruster.

The fuel and catalyst mixture control system 580 and intermediate catalyst control system 590, as described above, can be used to implement a variety of controlled combustion within the catalyst system 520 and thruster unit. For example, it can be appreciated by a person of ordinary skill in the art that the fuel and catalyst mixer control system 580 as well as intermediate catalyst control system 590 are adapted to control the rate of flow of fuel and any liquid catalysts through any supplemental port that may be provided. More specifically, the fuel and catalyst mixture control system 580 provides a carefully metered flow of fuel, such as RP-1, into the chamber for mixing with catalyst (such as potassium permanganate) at a rate that avoids flooding, explosive decomposition, or blockage and allows sufficient mixing of fuel and catalyst. In addition, the fuel and catalyst mixture control system 580 accounts for the addition of oxidizer provided to the mixture at a rate that accounts for the reaction of the mixture.

With respect to the embodiment shown in FIG. 14, an intermediate catalyst control system 590 can be provided, such as a computer or ASIC, to specifically control fuel flow into the different regions of the chamber 1110. The intermediate catalyst control system 590 can be adapted for introducing fuel at a regulated rate at one or more sections of the catalyst system 520. For example, in addition to the catalyst system 520 having a regulated port for receiving fuel at a top portion, such as pressure fed valve and/or pump system, the catalyst system 520 can include one or more distribution apertures or supplemental ports 1101 on the side of the system which can provide distribution of fuel/oxidizer or liquid catalyst at intermediate areas within the catalyst system, such as the spreader plate 522 would do at a top portion of the catalyst system. Preferably, such distribution apertures include a ring or tube around a section of the catalyst chamber to evenly distribute liquid fuel or liquid catalyst around the perimeter of the system chamber 1110.

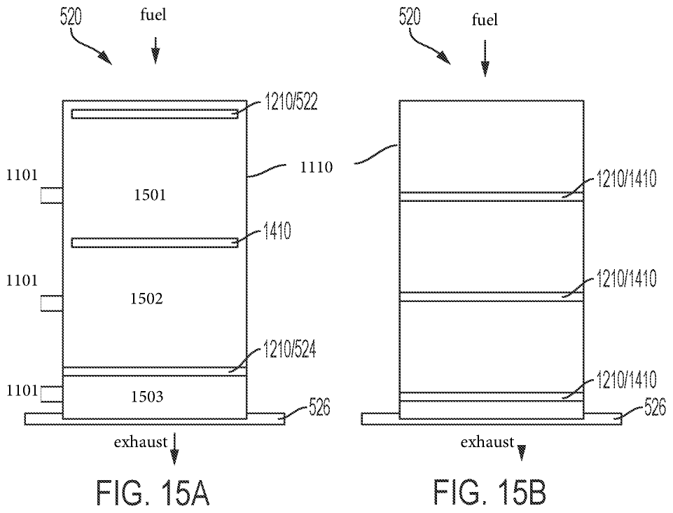

FIG. 15a and FIG. 15b show conceptual diagrams of alternative embodiments of the invention, wherein one or more catalysts can be separated with one or more separators 1410 or flow constrictors into different regions of the catalyst system 520, thereby providing flexibility in design and adaptability during a mission.

For example, as shown in FIG. 15a, a plurality of flow constrictors 1210 or separators 1410 are provided in a plurality of regions of the internal catalyst system chamber 1110. FIG. 15a is a conceptual representation of the catalyst system 520, similar to that shown in FIG. 14, but without a specific catalyst required. The separators 1410 provide separate internal regions 1501/1502/1503 for fuel and catalyst within the system chamber 1110.

Each separate region can be provided initially with one or more catalysts 1220, or remain empty, or be tillable with one or more catalysts from one or more supplemental catalyst ports 1101. Tor example, a first region 1501 can be fillable with a liquid from a supplemental catalyst port 1101, which, when it sets, provides a foam matrix for receiving fuel or catalyst. In this manner, the embodiment shown in FIG. 15a allows for a reusable catalyst in place of a catalyst, such as an alumina foam matrix as provided in the embodiment shown in FIG. 12 and FIG. 14, thereby providing in-space refueling of the catalyst system 520.

In one embodiment, three separators 1410 can be provided in a static, fixed position and thereby provide three empty regions for fuel/catalyst, through the catalyst system. For example, similar to FIG. 14, a flow constrictor 1210 in the form of a spreader plate 522 can be provided at a top/inlet and of the system, and thereafter a first region 1501 to receive a first catalyst can be provided and separated from a second region 1502 for a second catalyst by a separator 1410 such as a stainless-steel mesh. Thereafter a further separator 1410 can be provided in the form of an orifice plate 524 at an exhaust end.

In an alternative embodiment, the separator 1410 can be provided as a consumable mesh that degrades gradually as the first catalyst/fuel mixture is consumed, rather than a fixed non-consumable steel mesh.

In an alternative embodiment shown in FIG. 15b, three regions can be provided where the first region 1110 is before the first separator 1410 and provides an area free of catalysts for accumulation of fuel. Again, the separators 1410 are provided in a fixed position as in FIG. 15a.

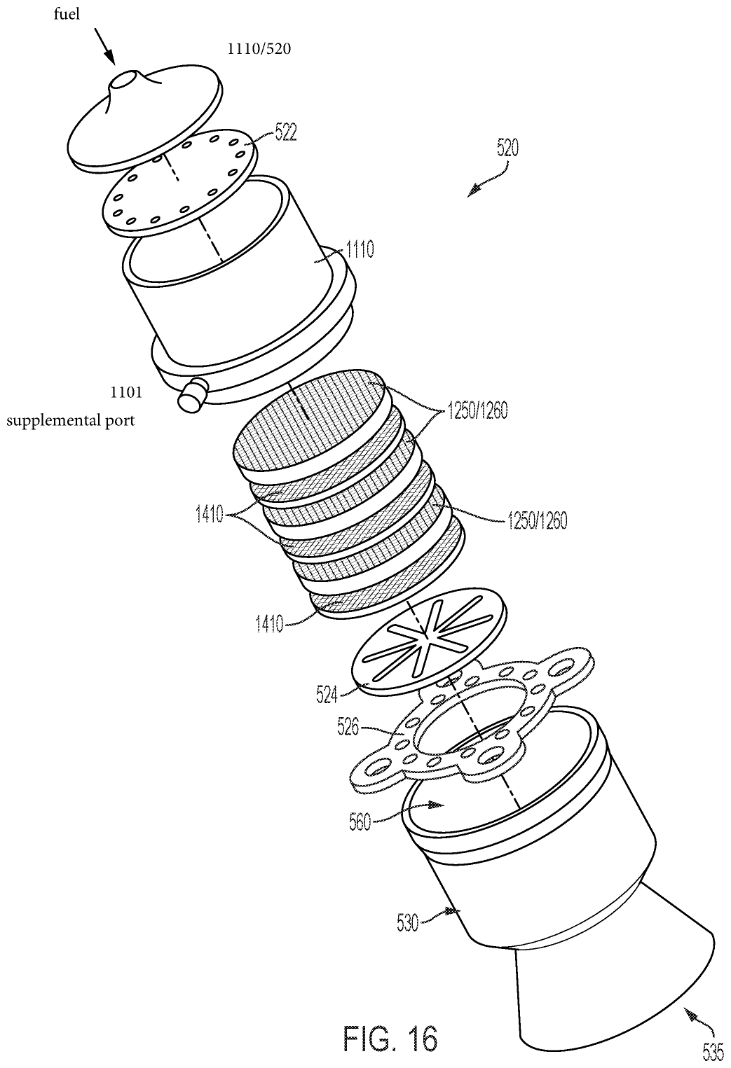

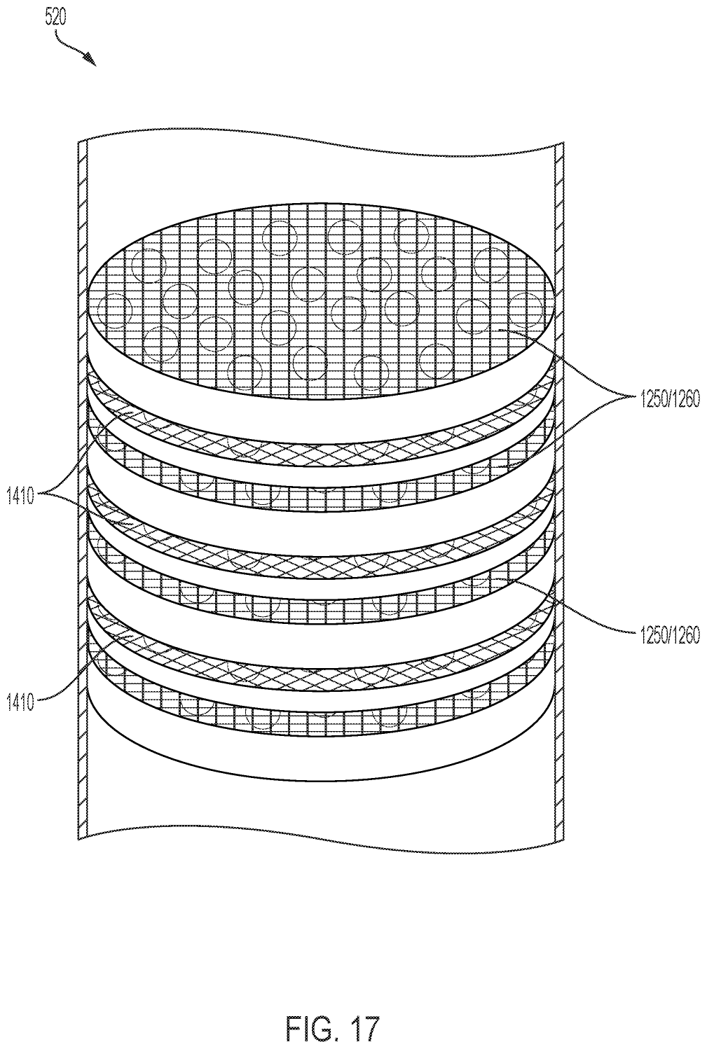

FIG. 16 shows an exploded three-dimensional view of an alternative embodiment of a catalyst system 520 according to the invention in combination with a thruster 530. The figure provides greater detail showing the differing orientation of separators 1410 wherein steel mesh screens are used to provide layers that separate a plurality of catalyst packages 1250 (not shown) containing a second catalyst within the internal catalyst system chamber 1110. The upstream separators can be provide having a mesh orientation about 45 degrees askew from mesh orientation of an adjacent or downstream separators.

In addition, downstream separators can be provided with a finer mesh than upstream separators, i.e., the holes of the mesh are smaller to catch the smaller pellets as they arc consumed so they do not blow through the system and can be fully utilized.

In addition, a supplemental catalyst port 1101 is shown provided as a ring conduit for the distribution of supplemental catalyst around the perimeter of the catalyst system chamber 1110, and has apertures (not shown) periodically spaced around the perimeter for the flow of supplemental catalyst into the chamber.

FIG. 18 shows a three-dimensional view of an alternative embodiment of a portion of a catalyst system 520 according to the invention, wherein a plurality of catalyst packages 1250 are provided in layers within the catalyst system chamber 1110. Each catalyst package 1250 includes at least one catalyst 1220 and a separator such as a mesh screen that encases the catalyst, such as solid pellets impregnated with catalyst.

The fuels adaptable for engines that are potentially runway safe can be adapted utilizing existing commercial airline technology, wherein alternative embodiments of the existing invention can be designed having a scale to replace conventional turbofan engines.

Additional fuel distribution and control components can be provided in alternative embodiments of the invention. The fuel and catalyst mixture system 580 introduces fuel into the catalyst system, either at a top portion (as described above) or into intermediate sections of the catalyst system. In addition, the intermediate catalyst control system 590 can provide for effectively mixing fuel and catalyst in a predetermined sequence, controlling the fuel and catalyst mixture system 580. It can be appreciated by persons of ordinary skill in the art that electrical, hydraulic, valves, and fuel lines can be provided for the above-described intermediate catalyst control systems and catalyst mixture systems.

Aspects of the embodiments described herein can be modified within the scope of the invention in order to adapt an embodiment of the catalyst system and aerospike engine to suit different purposes and under different conditions.

Various changes may be made to the system and process embodying the principles of the invention. The foregoing embodiments are set forth in an illustrative and not in a limiting sense. The scope of the invention is defined by the claims appended hereto.

1. A catalyst system for a rocket engine comprising:
A container having a fuel, input aperture at an input end thereof, and an exhaust aperture at an exit end thereof, a fuel spreader plate disposed proximate to the fuel input aperture and within the container,
an orifice plate disposed proximate to the exhaust aperture and within the container,
a catalyst chamber adapted to receive at least one catalyst, and
a supplemental port having at least one aperture at a perimeter of the catalyst chamber, wherein the supplemental port is provided at a downstream end of the catalyst chamber proximate to the orifice plate,
and wherein the catalyst system chamber is adapted to provide for convergent flow from the input end thereof towards the orifice plate, and divergent flow at an exit end thereof.

2. The catalyst system according to claim 1 further comprising a thrust ring, wherein the thrust ring is removably disposed at an at an exit end of the container, and wherein the thrust ring further comprises an aperture proximate to the orifice plate and adapted to receiving a divergent flow at an exhaust end of the orifice plate.

3. The catalyst system according to claim 1 wherein the catalyst system chamber further comprises a first catalyst disposed between the fuel spreader plate and orifice plate, and wherein the first catalyst is comprised of alumina foam impregnated with potassium permanganate, and wherein the supplemental port is adapted to receive hydrogen peroxide.

4. The catalyst system according to claim 1 wherein the catalyst system chamber further comprises a first catalyst disposed between the fuel spreader plate and orifice plate, and wherein the first catalyst is comprised a plurality of catalyst packages and at least one separator, and wherein the supplemental port is adapted to receive an oxidizer.

5. The catalyst system according to claim 1 wherein the catalyst system chamber further comprises a first catalyst system disposed downstream of the fuel spreader plate, a second catalyst system disposed downstream of the first catalyst system, and a separator disposed therebetween.

6. The catalyst system according to claim 1 wherein the catalyst system chamber further comprises a first catalyst disposed between the fuel spreader plate and orifice plate, and wherein the first catalyst is a non-consuming catalyst, comprised of at least one selected from the group comprising steel, platinum, palladium, and silver oxide, and wherein the supplemental port is adapted to receive an oxidizer.

7. The catalyst system according to claim 5 wherein at least one of the plurality of catalyst packages is comprised of sintered ceramic pellets impregnated with potassium permanganate.

8. The catalyst system according to claim 7 wherein a further of at least one of the plurality of catalyst packages is comprised of a catalyst selected from the group comprising alumina foam impregnated with potassium permanganate, sintered ceramic pellets impregnated with potassium permanganate, manganese dioxide, platinum, palladium and silver oxide.

9. The catalyst system according to claim 1 wherein the supplemental port is adapted to receive a catalyst for refilling the catalyst chamber.

10. The catalyst system according to claim 1 further comprising a catalyst and fuel system operatively connected to the fuel input aperture and supplemental port, and further comprising at least one fuel and catalyst selected from the group comprising: hydrogen peroxide, kerosine, RP-1.

11. The catalyst system according to claim 5, wherein the second catalyst system further comprises a mesh cage separator for containing a second catalyst.

12. The catalyst system according to claim 4 wherein the at least one separator includes at least one separator having a mesh orientation about 45 degrees askew from an adjacent at least one separator mesh orientation.

13. The catalyst system according to claim 4 wherein the at least one separator includes a downstream separator and an upstream separator, wherein the downstream separator has a mesh grade that is finer than a mesh grade of the upstream separator.

14. The catalyst system according to claim 4 wherein the at least one separator includes a wire a non-consumable catalyst selected from the group consisting of platinum, silver and palladium.

15. The catalyst system according to claim 1 further comprising a thruster having a combustion chamber at an exhaust end of the thrust ring, and a nozzle, wherein the thruster is adapted to provide a second convergent flow from the input end of the nozzle, and a second divergent flow at an exit end of the nozzle.
